(19) United States
(12) Patent Application Publication
(10) Pub. No.: US 2003/0010175 A1
(43) Pub. Date: Jan. 16, 2003

(54) Ridge cap cutter

(76) Inventors: Randall D. Cohan, Springfield, IL (US); Jill Susann Cohan, Springfield, IL (US)

Correspondence Address: Joseph H. McGlynn, 6111 Saddle Horn Dr., Fairfax, VA, 22030, US

(21) Appl. No.: 09/902,755

(22) Filed: Jul. 12, 2001

(51) Int. Cl. B26F 1/12; B26F 1/42; B26D 5/16; B26D 5/10

(52) U.S. Cl. 83/618; 83/628; 83/633; 83/637; 83/541; 83/917; 83/582; 83/692

(57) ABSTRACT

A cutting device for shingles that cuts shingles at angles. Several blades, each on pressure plates, are forced into engagement with shingles by rollers that engage one side of the plates.

### BACKGROUND OF THE INVENTION

This invention relates to a shingle cutting device used when roofing a structure with a roof cap.

Today and for many years past, ridge cap shingles have been cut by hand. Such hand cutting is a highly labor intensive and time consuming process. To reduce the time used to cut the shingles and to save money, devices have been developed that cut shingles. Typically, these devices employ a cutter that in brought in contact with the shingle to be cut by a hand operated handle. To protect the user, guards or other protective surfaces may be used.

### DESCRIPTION OF THE PRIOR ART

Devices that can be used to cut shingles are known in the prior art. For example, U.S. Pat. No. 4,951,540 to Cross et al. discloses a shingle ridge cap cutter having a pivoting blade cutter.

U.S. Pat. No. 5,052,256 to Morrissey discloses a shingle cutter having a lever arm with a pair of diverging cutting blades.

U.S. Pat. No. 5,392,677 to Sevart et al. discloses a shingle cutter which makes a cut across the shingle at a selected angle.

U.S. Pat. No. 5,787,781 to Hile discloses a shingle cutter with a pivoting cutting blade.

U.S. Pat. No. 6,112,413 to Frakes et al. discloses a shingle cutter with an upper and lower portion which cuts shingles.

The present invention is directed to a device having a base with cutter blades and an upper portion with pressure rollers to force the shingle into the cutters, all as will be detailed in the specification that follows hereafter.

### SUMMARY OF THE INVENTION

This invention relates to a cutting device for shingles that cuts shingles at angles.

It is the primary object of the present invention to provide for an improved cutting device for shingles.

Another object is to provide for such a device in which the shingles are cut at angles to accommodate the valley of hip and valley roofs.

These and other objects and advantages of the present invention will become apparent to readers from a consideration of the ensuing description and the accompanying drawings.

### BRIEF DESCRIPTION OF THE DRAWINGS

FIG. 1 is a perspective view of the present invention showing the base and cutters along with the upper handle structure.

FIG. 2 is another perspective view of the device shown in FIG. 1 as viewed from another angle.

FIG. 3 is a side view of the device.

FIG. 4 is a still another perspective view of the device from a slightly different angle than those of FIGS. 1 and 2.

### DESCRIPTION OF THE PREFERRED EMBODIMENT

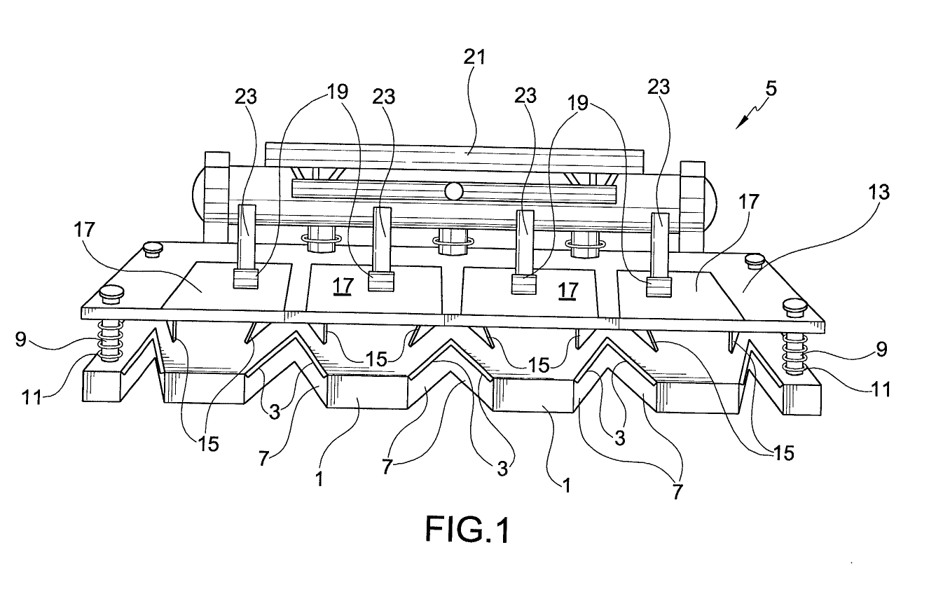

FIG. 1 is a perspective view of the present invention showing the base 1 and cutters 3 along with the upper handle structure 5. The base 1 has several rearward facing V-shaped slots 7. There are raised lips on base 1 at the rear and side surfaces outside of the six supporting posts 9, two of which are shown. Six compression springs 11 are placed on each of the posts 9. Above, and spaced from the base 1, is the cutter plate 13. Each post 9 extends through a hole in the plate 13. On the underside of plate 9 are several V-shaped cutting blades 15. The blades 15 are mounted over the shingle placement guide cutters 3. The plow of the blades 15 faces toward the rear of plate 13. Above the blades 15 are apical mounted pressure plates 17. Each plate 17 is engageable by a pressure roller 19 from above. A horizontally disposed handle 21 is above the rollers 19.

The actuation of handle 21 causes the pressure rollers 19 to move downwardly to engage their respective pressure plates 17. Pressure arms 23, attached to the rollers 19, mount the rollers over the pressure plates 17. A shaft (not shown) within a housing mounts the pressure arms 23. A downward force on handle 21 causes the arms 23, rollers 19, and engaged plates 17 to move downwardly along with the cutting blades 15 towards the in-place shingle.

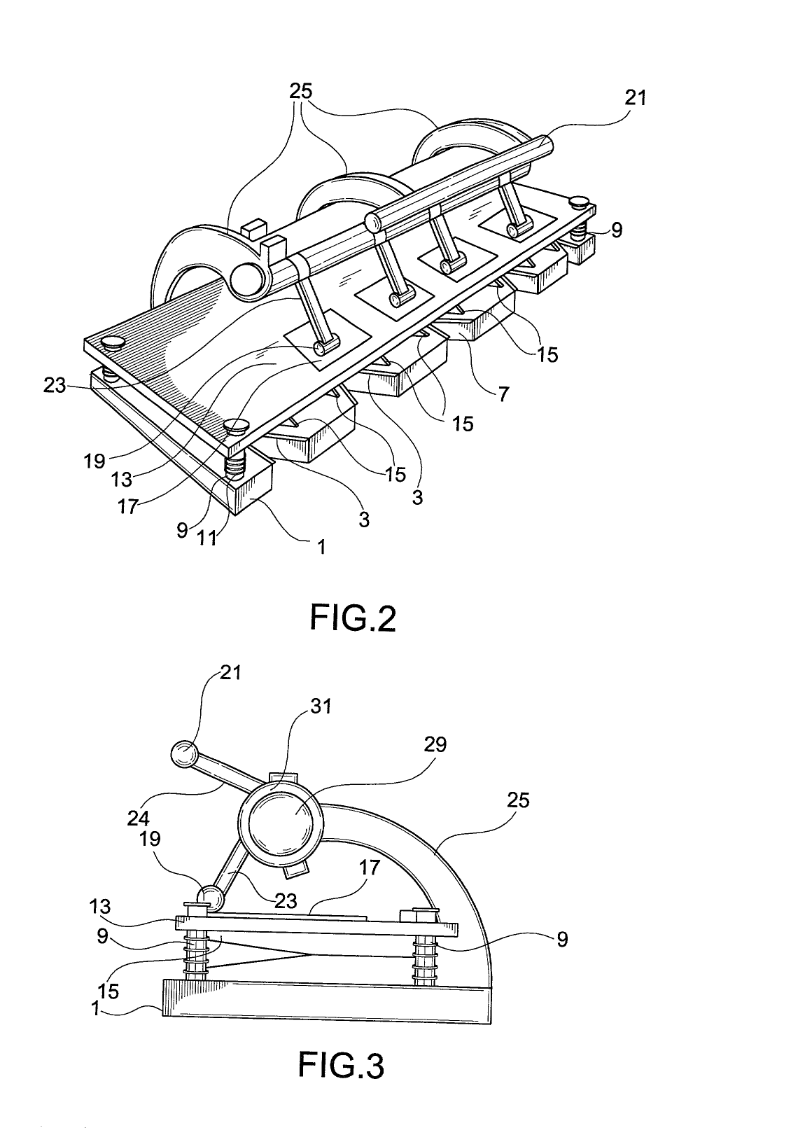

FIG. 2 is another perspective view of the device shown in FIG. 1 as viewed from another angle. In this view the handle 21 is positioned over the plate 13 along with the arms 23 and rollers 19. Downward pressure on handle 21 moves the rollers 19 downwardly to depress the pressure plates 17. At the same time, the cutting blades 15 move with the plates 17 into a cutting position to cut any shingles placed between the blades 15 and the lower cutters guides 3. The cutting edges of cutters 3 extend along the sides of the slots 7 and slightly above the surface of plate 1.

Depicted in FIG. 2 are three curved mounts 25 used to mount a housing which supports the shaft carrying handle 21. One end of each mount 25 is fixed to the base 1. The curved mounts 25 permit the handle 21 to extend over the plate 13.

FIG. 3 is a side view of the present invention. In this view, one of the arms/rollers 23, 19 is shown engaging a pressure plates 17. The handle 21 has spaced arms 24 to connect it to a rotatable shaft 29, whose end is shown. The flat base 1 is positioned on a supporting surface, like the ground, a table, or a floor. The side posts 9 and springs 11 permit the plate 13 to move vertically relative to base 1. Each of the pressure plates 17, when engaged by a roller 19, moves downwardly along with its blade 15. By preselecting the angles, for the different V-shaped slots 7, cutter 3 and blades 15, different angular cuts may be made to shingles. If desired, different angular cuts may be made for each separate slot 7, cutter 3 and blades 15 combination to accommodate different angular cuts for hip or valley roofs. For very steep angles the end separation between slots 7 would be very slight. For less steep angular cuts, the end separation for slot 7 would be greater. The shaft 29 is round and cylindrical. The shaft end is centered within the housing 31. Also within the housing 31 are conventional bearing rollers around the shaft 29 and a circular sealing bracket, neither of which is shown.

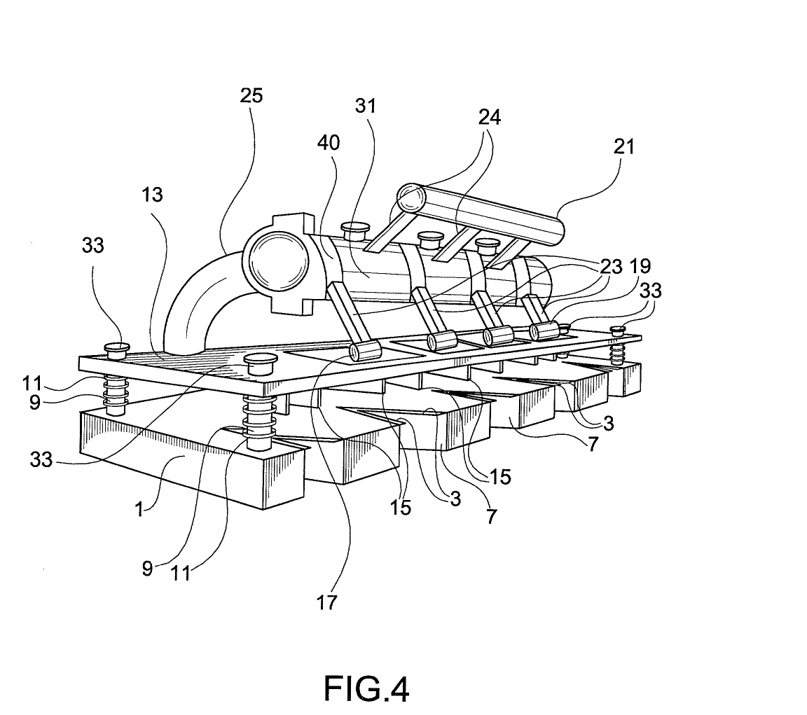

FIG. 4 is a still another perspective view of the device from a slightly different angle than those shown in FIGS. 1 and 2. Internal cutting head spring washers on housing shaft 29 normally maintain the position of handle 21 and its arms 24 in the elevated position. When a user exerts downward pressure on handle 21, which is attached to the housing 31, the shaft 29 rotates to move arms 23. Rollers 23 are attached to the housing by clamps 40. The posts 9 of plate 13 extend through the plate and have enlarged end caps 33 on top of the plate 13. With the springs 11 below plate 13, a flexible mounting is provided between plate 13 and base 1 to allow for the desired depression of plate 13 and pressure plates 17 relative to the base 1.

Many of the individual components making up the present invention can be made of construction quality steel or aluminum, or both. In use, a shingle to be cut at a desired angle is placed in a selected slot 3. When the shingle is placed within markings on the base 1 and plate 13, the slot placement guide cutters 3 are located below the upper blades 15. Next, the handle 21 is moved to depress the blades 15. The blades 15 and guide cutters 3 are just out of direct alignment with each other. This alignment insures the shingle will be cut from two sides at almost exactly the same straight line location on both sides of the shingle. Clearly, the manually operated handle 21 could be replaced by a pneumatic operation or a gear reduction system if needed or desired.

Although the preferred embodiment of the present invention and the method of using the same has been described in the foregoing specification with considerable details, it is to be understood that modifications may be made to the invention which do not exceed the scope of the appended claims and modified forms of the present invention done by others skilled in the art to which the invention pertains will be considered infringements of this invention when those modified forms fall within the claimed scope of this invention.

What I claim as my invention is:

1. A cutting device for shingles comprising:
a base having slots cut at angles,
a plate movably mounted over said base,
said plate being mounted to the base by posts,
pressure plates in said plate movable with respect to the base,
blades mounted on a downwardly facing surface of said pressure plates at the same angle as the slot,
means for moving the blades towards the base,
whereby a shingle placed over a slot may be cut at the same angle as the slot by the blades.

2. The cutting device as claimed in claim 1, wherein said means for moving the blades comprises:
a handle,
a roller with an attached arm at a first end,
said roller engaging a pressure plate, and
said arm being mounted to move with the handle at a second end.

3. The cutting device as claimed in claim 2, wherein said means for moving the blades further comprises:
a rotatable shaft attached to the handle at an end opposite said second end.

4. The cutting device as claimed in claim 3, wherein the slots, cut at angles, are V-shaped with guide cutters along the side edges of the slots facing toward the blades.

5. The cutting device as claimed in claim 4, wherein the handle of said means for moving the blades is normally maintained in an elevated position above said base,
said rollers apply pressure to the pressure plates when a downward pressure is applied to the handle.

6. The cutting device as claimed in claim 5, wherein said posts extend through the plate, and
there are springs on the posts below the plate to normally maintain the plate in an elevated position,
whereby said plate is elevated until the handle is depressed.
